(19) United States
(12) Patent Application Publication
(10) Pub. No.: US 2003/0056711 A1
(43) Pub. Date: Mar. 27, 2003

(54) Pressure indication device

(76) Inventor: Brian R. Tranter, High Wycombe (GB)

Correspondence Address: Iandiorio & Teska, 260 Bear Hill Road, Waltham, MA, 02451-1018, US

(21) Appl. No.: 09/963,775

(22) Filed: Sep. 26, 2001

(51) Int. Cl. G01L 19/10

(52) U.S. Cl. 116/272; 116/268

(57) ABSTRACT

A pressure indication device including a housing with an opening in communication with a pressure vessel, a plunger moveable in the housing between a pressurized position and a non-pressurized position, a seal between the opening and the plunger, an indicator over the plunger and biased into a flag position, and a locking mechanism for holding the indicator in a set position until the plunger moves to the non-pressurized position whereupon the indicator returns to the flag position.

### FIELD OF THE INVENTION

This invention relates to a pressure indication device useful, for example, in connection with accumulators.

### BACKGROUND OF THE INVENTION

Hydraulic accumulators provide a temporary reserve of fluid under pressure. A typical accumulator includes a separator in a chamber that separates a volume of gas from the non-compressible hydraulic oil. When the system is operating, the hydraulic oil pressure drives the separator to compress the gas. To achieve the desired performance characteristics, the gas is precharged such that even when all the oil is discharged from the accumulator the gas remains pressurized. Loss of gas pressure due to leakage will result in accumulator performance being degraded.

It is therefore desirable to be able to detect whether the gas charge pressure in an accumulator is sufficient. Typical prior art pressure gages can leak and are not maintenance free. Prior art pressure gages also fail to provide a positive indication that the gas pressure went below a minimum pressure earlier in time when thereafter the gas pressure has increased by the action of the hydraulic fluid.

### SUMMARY OF THE INVENTION

It is therefore an object of this invention to provide a more useful pressure indication device.

It is a further object of this invention to provide such a pressure indication device which relies only on mechanical components.

It is a further object of this invention to provide such a pressure indication device which is not be reset simply by repressurizing the pressure vessel it is connected to.

It is a further object of this invention to provide such a pressure indication device which utilizes a welded metal bellows to isolate the indicator from pressurized fluid rendering the pressure indication device fully leak tight, sealed for life, and maintenance free.

It is a further object of this invention to provide such a pressure indication device which isolates pressure spikes from the bellows increasing the reliability of the device in relation to fatigue.

It is a further object of this invention to provide such a pressure indication device which includes a partial seal which assists in the actuation of the bellows.

It is a further object of this invention to provide such a pressure indication device which can be inexpensively manufactured, reliably reproduced, and small and compact in design.

This invention results from the realization that a leak proof, maintenance free, simple in design, and low cost pressure indication device for an accumulator or any other pressure vessel can be effected by a plunger sealed with respect to a housing coupled to the accumulator or pressure vessel by a bellows in combination with an indicator which must be set, which pops up when the gas pressure falls below a predetermined minimum, and which stays up even if the gas pressure later returns to a nominal level.

This invention features a pressure indication device comprising a housing including an opening in communication with a pressure vessel; a plunger moveable in the housing between a pressurized position and a non-pressurized position; a seal between the opening and the plunger; an indicator over the plunger and biased into a flag position; and a locking mechanism for holding the indicator in a set position until the plunger moves to the non-pressurized position whereupon the indicator returns to the flag position.

In the preferred embodiment, the locking mechanism includes a ledge on the housing, at least one tang on the indicator, and a surface on the plunger which forces the tang under the ledge when the plunger is in the pressurized position and the indicator is in the set position. The tang is biased inwardly away from the ledge and the plunger surface then drives the tang outwardly under the ledge. Also, in the preferred embodiment, the seal is a bellows seal.

Typically, there is a compression spring about the plunger contacting, on one end, the plunger and contacting, on the other end, the indicator. Also, the housing is made of press fit multiple components. A stop member preferably disposed between the plunger and the housing at least partially seals the opening when the plunger is in the pressurized position. In one embodiment, a distal end of the indicator extends out of the housing when the indicator is in the flag position.

The pressure indication device of this invention features a housing; a plunger movable in the housing between a pressurized position and a non-pressurized position; and a bellows seal connected between the housing and the plunger biasing the plunger into the non-pressurized position and flexibly sealing the plunger with respect to the housing. In the preferred embodiment, an indicator is disposed over the plunger and biased into a flag position and there are means for releasably locking the indicator in a set position. The means for releasably locking typically includes a ledge on the housing, tangs on the indicator, and a surface on the plunger which forces the tangs under the ledge when the plunger is in the pressurized position and the indicator is in the set position. The tangs are biased inwardly away from the ledge and the plunger surface drives the tangs outwardly under the ledge.

There is a compression spring about the plunger contacting, on one end, the plunger and contacting, on the other end, the indicator and a stop member between the plunger and the housing which at least partially seals the opening when the plunger is in the pressurized position. One completely assembled pressure indication device in accordance with this invention has a housing including an opening in communication with a pressure vessel and an inner ledge; a plunger moveable in the housing between a pressurized position and a non-pressurized position, the plunger including a cone portion; a bellows seal connected between the opening and the plunger; an indicator moveable between a set position and a flag position, the indicator disposed over the plunger and including at least one inwardly biased tang driven outward under the inner ledge of the housing by the cone portion of the plunger when the plunger moves to the pressurized position and the indicator is forced into the set position; and a spring about the plunger which biases the indicator into the flag position such that when the plunger moves to the non-pressurized position the tang of the indicator moves inwardly free of the ledge and the spring drives the indicator to the flag position where it remains even if the plunger moves back to the pressurized position.

### BRIEF DESCRIPTION OF THE DRAWINGS

Other objects, features and advantages will occur to those skilled in the art from the following description of a preferred embodiment and the accompanying drawings, in which:

FIG. 1 is a schematic block diagram of one example of a hydraulic system incorporating an accumulator to which the subject invention relates;

FIG. 2 is a schematic cross sectional view of the accumulator shown in FIG. 1 incorporating the pressure indication device of the subject invention;

FIG. 3 is a schematic cross sectional view of the pressure indication device shown in FIG. 2;

FIG. 4 is a schematic three dimensional view showing the indicator of the pressure indication device shown in FIG. 3 and;

FIG. 5 is a schematic three-dimensional view of the plunger of the pressure indication device shown in FIG. 3.

### DISCLOSURE OF THE PREFERRED EMBODIMENT

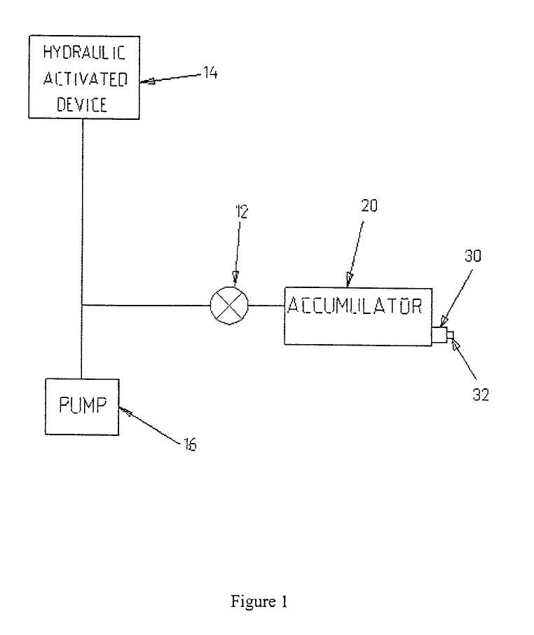

As discussed in the background section above, accumulator 20, FIG. 1 provides a limited reserve source of hydraulic fluid under pressure via valve 12 for hydraulically actuated device 14. See U.S. Pat. No. 5,638,868 and copending patent application Ser. No. 09/880,312 filed Jun. 13, 2001, both of which are hereby incorporated herein by this reference.

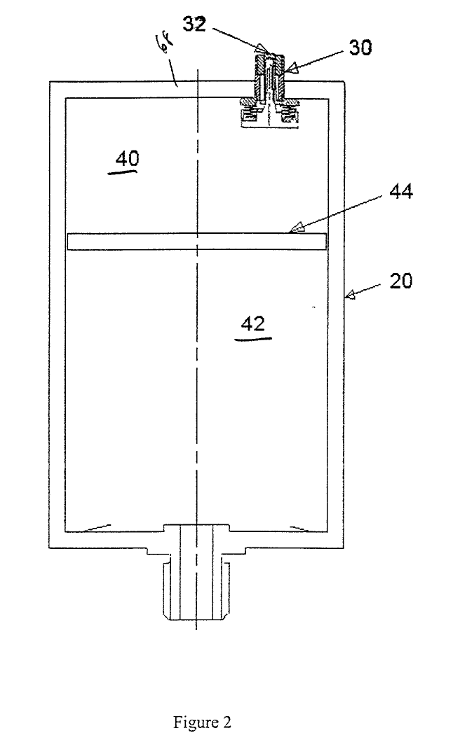

Referring to FIG. 2, pressure indication device 30 in accordance with this invention provides a positive indication when the gas pressure inside accumulator 20 falls below a nominal pressure level. When this happens, a “flag” 32 pops out and is readily noticeable by inspection and maintenance personnel. Moreover, flag 32 stays out even if the gas pressure inside accumulator 20 returns to a nominal pressure level thereby providing a positive indication that the gas pressure, earlier in time, fell below the nominal pressure level. In this way, inspection and/or maintenance personnel can investigate or troubleshoot why accumulator 20 lost its gas pressure and replace it or its components as necessary.

Pressure indication device 30, FIG. 2 is installed in communication with gas chamber 40 of accumulator 20 through wall 68. Separator 44 divides accumulator 20 into gas chamber 40 and liquid (hydraulic fluid) chamber 42.

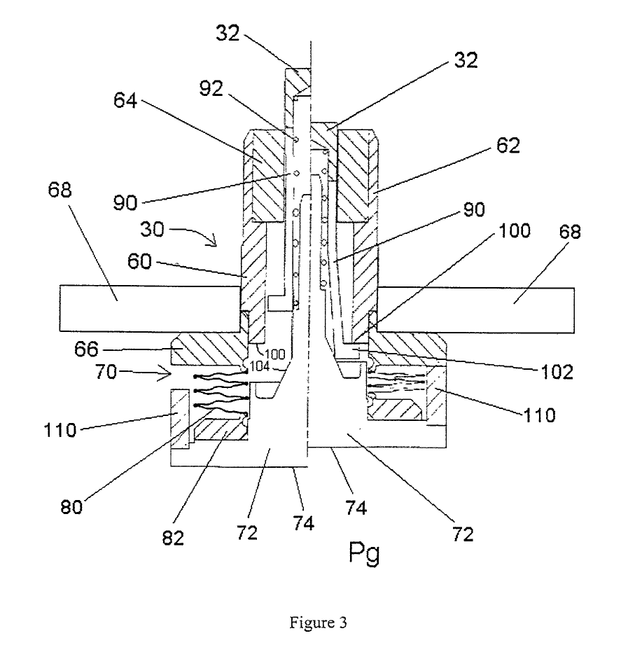

FIG. 3 shows the primary components associated with pressure indication device 30. The left half of FIG. 3 shows the condition where “flag” 32 is out; the right half of FIG. 3 shows the condition when flag 32 is set.

Device 30 includes housing 60 which, in the preferred embodiment, includes three components: body 62, retainer 64, and flange 66 all of which are joined during the assembly of device 30. Flange 66 mates with the pressure vessel shown in FIG. 3 via wall 68. Opening 70 below flange 66 is thus in communication with the inside of the pressure vessel. Housing 60 can be made small, for example, 30 mm tall and 20 mm in diameter.

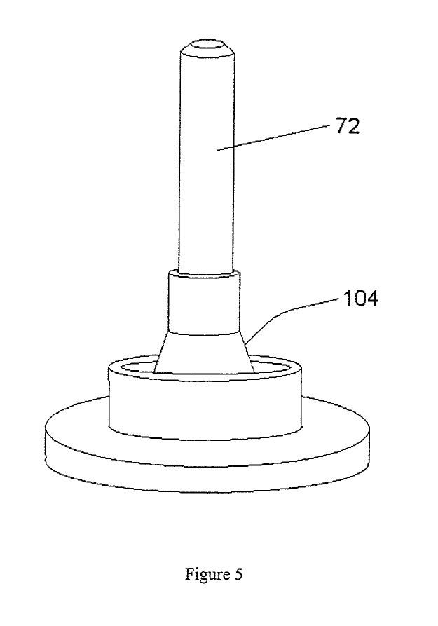

Plunger 72, FIGS. 3 and 5, is moveable within housing 60 between a pressurized position as shown in the right half of FIG. 3 and a non-pressurized position as shown in the left half of FIG. 3. In the non-pressurized position, little or no gas pressure is acting on bottom surface 74 of plunger 72. In the pressurized position, the nominal gas pressure inside the pressure vessel is acting on plunger 72 moving it up in FIG. 3. Seal 80, which, in the preferred embodiment is a bellows, flexibly connects adapter 82 attached to plunger 72 and flange 66 of housing 60. Accordingly, the outer side of bellows 80 is at the gas pressure and the inside of bellows 80 is at atmospheric or ambient pressure. Indicator 90 is disposed over plunger 72 and biased into a flag position (e.g., “out” as shown in the left hand side of FIG. 3) by compression spring 92.

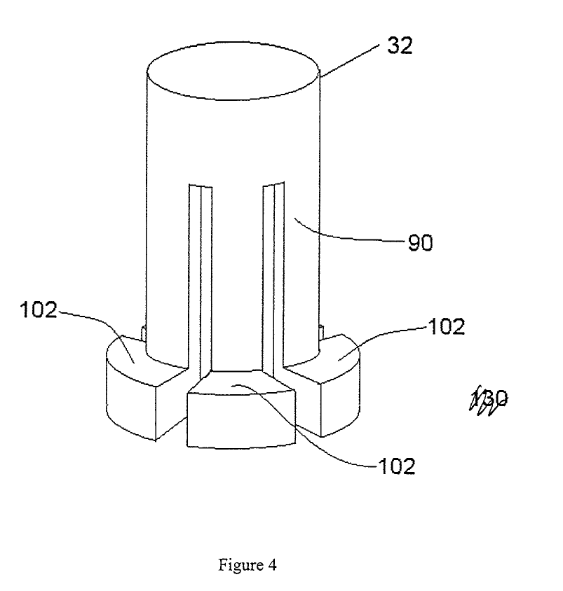

To ‘set’ indicator 90, FIGS. 3 and 4, it is manually pressed into the housing 60. When the system is pressurized, gas pressure acts on plunger 72 and compresses bellows 80 and cone portion 104 of plunger 72 is forced into the end of indicator 32 causing it to spread out and lock in the housing.

The preferred locking mechanism or means includes three primary components: ledge 100 on housing 60 defined by body 60 and flange 66; inwardly biased tang 102 on the distal end of indicator 90; and cone shaped surface 104 on plunger 72 which forces tang 102 under ledge 100 (see the right hand side of FIG. 3) when plunger 72 is in the pressurized position and indicator 90 is in the set position.

When, however, the gas pressure inside the vessel drops below a nominal level, bellows 80 naturally returns to it free length as shown in the left hand side of FIG. 3 since no pressure is acting on the bottom surface 74 of plunger 72. Cone surface 104 of plunger 72 then moves down, tang 102 of indicator 90 springs back into a relaxed state and indicator 90 and flag 32 move upward by the action of compression spring 92 since there is now adequate clearance for tang 102 to move inside body 60 until it reaches either retainer 64 or the full relaxed extent of spring 92.

If, however, the gas pressure returns and plunger 72 moves upward, its movement is independent of indicator 90 and indicator 90 is not affected and does not move: in this way, flag 32 stays out until manually pressed back down and will only stay down if plunger 72 is up under the influence of the nominal gas pressure whereupon only then does cone surface 104 cause tang 102 to splay outwardly under ledge 100 locking indicator 90 and flag 32 in the down position as shown in the right hand side of FIG. 3.

The following table is designed to assist in an understanding of the operation of the primary components associated with pressure indication device 30 where P_{g} is the gas pressure as shown in FIG. 3.

| Indicator 90 | Flag 32 | Pg. | Plunger 72 | Stop 110 | Bellows 80 | Spring 92 | Tang 102 |
|---|---|---|---|---|---|---|---|
| Locked | Down | P_{g} > | Up | Up | Compressed | Compressed | Engaged |
| down(set) | | Pre- | (press- | | | | under |
| | | defined | urized | | | | ledge 100, |
| | | minimum | position) | | | | spayed |
| | | | | | | | outwardly |
| Up (loss | Up | P_{g} < | Down | Down | Released | Relaxed | Free of |
| of | | Pre- | | | (free length) | | edge 100, |
| pressure) | | defined | | | | | biased |
| | | minimum | | | | | inwardly |
| Up | Up | P_{g} > | Up | Up | Compressed | Relaxed | Free of |
| (pressure | | Pre- | | | | | ledge 100, |
| returns to | | defined | | | | | biased |
| nominal | | minimum | | | | | inwardly |
| after loss | | | | | | | |
| of | | | | | | | |
| pressure) | | | | | | | |

Accordingly, one feature of the subject invention is that once flag 32 is out and indicator 90 is up, subsequent movement of plunger 72 does not affect this position providing inspection and maintenance personnel with a positive indication that, earlier in time, the vessel pressure dropped below a predetermined minimum.

Another feature of the subject invention is that pressure indicator device 30 is formed entirely of mechanical components and utilizes a welded metal bellows to isolate external indicator 32 from the pressurized fluid making it fully leak tight and sealed for life.

Still another feature of the subject invention is that stop 110 forms a partial seal with plunger 72. During operation, the cavity formed between stop 110 and bellows 80 becomes pressurized. The partial seal, however, serves two purposes. Pressure spike are isolated from bellows 80 increasing its reliability in relation to fatigue and, when the device is required to operate, the “sealed” pressure assists in the actuation of bellows 80.

Pressure indication device 30 features pop out indicator 32 the flag end of which is normally flush with the surface of housing 62. A loss of pressure indication occurs when flag 32 pops out protruding a distance (for example, 5 mm) which is visibly clear to anyone performing an inspection. As such, the device functions when pressure is released. This causes bellows 80 to extend back to its free length releasing indicator 32 from the locking mechanism which is then forced out of the device under the influence of spring 90. Repressurizing the device under these conditions compresses bellows 80 back to its original installed length, but indicator pin 32 remains extended.

The result is a more useful pressure indication device which relies only on mechanical components. The pressure indication device cannot be reset simply by repressurizing the pressure vessel it is connected to. A welded metal bellows isolates the indicator from the pressurized fluid rendering the pressure indication device fully leak tight, sealed for life, and maintenance free. Pressure indication device 30 can be inexpensively manufactured, is reliably reproduced, and is small and compact in design.

Leak proof, maintenance free, simple in design, and low cost pressure indication device 30 for an accumulator or any other pressure vessel includes a plunger 72 sealed with respect to housing 66 coupled to the accumulator or pressure vessel by bellows seal 80 in combination with indicator 90 which must be set, which pops up when the gas pressure falls below a predetermined minimum, and which stays up even if the gas pressure later returns to a nominal level.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A pressure indication device comprising:
a housing including an opening in communication with a pressure vessel;
a plunger moveable in the housing between a pressurized position and a non-pressurized position;
a seal between the opening and the plunger;
an indicator over the plunger and biased into a flag position; and
a locking mechanism for holding the indicator in a set position until the plunger moves to the non-pressurized position whereupon the indicator returns to the flag position until it is reset.

2. The pressure indication device of claim 1 in which the locking mechanism includes a ledge on the housing, at least one tang on the indicator, and a surface on the plunger which forces the tang under the ledge when the plunger is in the pressurized position and the indicator is in the set position.

3. The pressure indication device of claim 2 in which the tang is biased inwardly away from the ledge and the plunger surface drives the tang outwardly under the ledge.

4. The pressure indication device of claim 1 in which the seal is a bellows seal.

5. The pressure indication device of claim 1 in which there is a compression spring about the plunger contacting, on one end, the plunger and contacting, on the other end, the indicator.

6. The pressure indication device of claim 1 in which the housing is made of multiple components.

7. The pressure indication device of claim 1 further including a stop member between the plunger and the housing which at least partially seals the opening when the plunger is in the pressurized position.

8. The pressure indication device of claim 1 in which a distal end of the indicator extends out of the housing when the indicator is in the flag position.

9. The pressure indication device of claim 2 in which the indicator includes a plurality of tangs.

10. A pressure indication device comprising:
a housing;
a plunger movable in the housing between a pressurized position and a non-pressurized position; and
a bellows seal connected between the housing and the plunger biasing the plunger into the non-pressurized position and flexibly sealing the plunger with respect to the housing.

11. The pressure indication device of claim 10 further including an indicator over the plunger and biased into a flag position.

12. The pressure indication device of claim 11 further including means for releasably locking the indicator in a set position.

13. The pressure indication device of claim 12 in which said means for releasably locking includes a ledge on the housing, at least one tang on the indicator, and a surface on the plunger which forces the tang under the ledge when the plunger is in the pressurized position and the indicator is in the set position.

14. The pressure indication device of claim 13 in which the tang is biased inwardly away from the ledge and the plunger surface drives the tang outwardly under the ledge.

15. The pressure indication device of claim 11 in which there is a compression spring about the plunger contacting, on one end, the plunger and contacting, on the other end, the indicator.

16. The pressure indication device of claim 10 further including a stop member between the plunger and the housing which at least partially seals the opening when the plunger is in the pressurized position.

17. The pressure indication device of claim 11 in which a distal end of the indicator extends out of the housing when the indicator is in the flag position.

18. A pressure indication device comprising:
a housing including an opening in communication with a pressure vessel and an inner ledge;
a plunger moveable in the housing between a pressurized position and a non-pressurized position, the plunger including a cone portion;
a bellows seal connected between the opening and the plunger;
an indicator moveable between a set position and a flag position, the indicator disposed over the plunger and including at least one inwardly biased tang driven outward under the inner ledge of the housing by the cone portion of the plunger when the plunger moves to the pressurized position and the indicator is forced into the set position; and
a spring about the plunger which biases the indicator into the flag position such that when the plunger moves to the non-pressurized position the tang of the indicator moves inwardly free of the ledge and the spring drives the indicator to the flag position where it remains until it is manually returned to the set position even if the plunger moves back to the pressurized position.

19. The pressure indication device of claim 18 in which the housing is made of multiple components.

20. The pressure indication device of claim 18 further including a stop member between the plunger and the housing which at least partially seals the opening when the plunger is in the pressurized position.

21. The pressure indication device of claim 18 in which a distal end of the indicator extends out of the housing when the indicator is in the flag position.

22. The pressure indication device of claim 18 in which the indicator includes a plurality of tangs.
